(19) United States
(12) Patent Application Publication
(10) Pub. No.: US 2025/0363245 A1
(43) Pub. Date: Nov. 27, 2025

(54) SYSTEMS AND METHODS FOR MANAGING A SECURE CLOUD BASED ENCLAVE WITHOUT BREACH OF USER PRIVACY

(71) Applicant: Affle (India) Limited, India, Gurugram (IN)

(72) Inventors: ANUJ KHANNA SOHUM, Singapore (SG); CHARLES YONG JIEN FOONG, Templestowe (AU); MADHUSUDANA RAMAKRISHNA, Singapore (SG)

(73) Assignee: Affle (India) Limited, India, Gurugram (IN)

(21) Appl. No.: 19/209,232

(22) Filed: May 15, 2025

(30) Foreign Application Priority Data
May 24, 2024 (IN) IN202311077716

(51) Int. Cl. G06F 21/62; G06F 21/60; H04L 67/10

(52) U.S. Cl. CPC G06F 21/6263; G06F 21/602; H04L 67/10

(57) ABSTRACT

System and method for preventing breach of user privacy in a secure cloud-based enclave. The method comprises receiving, by a data acquisition module associated with the secure cloud-based enclave, user data from external sources. The data acquisition module classifies the user data into multiple categories, such as general information, personal information, and secret information. The data acquisition module applies data transformations to the user data based on the multiple categories to generate transformed data. Further, a training module associated with the secure cloud-based enclave, trains user-specific Artificial Intelligence (AI) models based on the transformed data. Furthermore, an AI agent associated with the secure cloud-based enclave executes the user-specific AI models to perform an action associated with the user data and provides a result of the action to an external system through an external interface.

### CROSS-REFERENCE TO RELATED APPLICATIONS

This patent application claims priority to Indian Patent Application No. IN 202311077716, filed May. 15, 2024, entitled “SYSTEMS AND METHODS FOR MANAGING A SECURE CLOUD BASED ENCLAVE WITHOUT BREACH OF USER PRIVACY,” and assigned to the assignee hereof. The disclosure of the prior application is considered part of and is incorporated by reference in this patent application.

### TECHNICAL FIELD

Embodiments of the present disclosure generally relate to Artificial Intelligence (AI) based systems and more particularly to a system and a method for managing a secure cloud-based enclave wherein the data related to agent is stored, accessed and trained without breach of user privacy.

### BACKGROUND

In recent years, the digital landscape has witnessed a remarkable surge in the capabilities of Artificial Intelligence (AI) and Machine Learning (ML). These transformative technologies have permeated nearly every facet of our lives, from personalized digital assistants and recommendation systems to autonomous vehicles and advanced medical diagnostics. As AI continues to evolve, the potential to enhance our daily experiences, streamline processes, and solve complex problems is undeniable. However, this surge in AI's power has also given rise to a crucial and ever-pressing concern: the need to harmonize this remarkable potential with the imperative to safeguard individual privacy.

The very essence of artificial intelligence lies in its ability to learn and adapt from vast volumes of data. ML algorithms excel at recognizing patterns, drawing insights, and making predictions based on the information they are provided. While this data-driven approach fuels the remarkable progress we've seen, it simultaneously underscores the importance of protecting the privacy and personal information of individuals. This dynamic tension is at the heart of a complex and evolving challenge. As AI and ML continue their rapid advancements, the growing need to strike a delicate balance between maximizing their capabilities and ensuring that individuals' sensitive information remains confidential becomes increasingly evident. Users rightly expect innovative AI solutions, but they also demand robust safeguards to prevent their data from falling into the wrong hands or being misused. Hence, the pursuit of harnessing AI's full potential goes hand in hand with the imperative of upholding individual privacy rights in this data-driven world, making it a paramount concern that informs and shapes technological advancements and regulatory frameworks alike.

Consequently, there is a need for improved systems and methods for preventing breach of user privacy in a secure cloud-based enclave.

### OBJECTS OF THE INVENTION

A general objective of the present disclosure is to provide a system and a method for preventing breach of user privacy in a secure cloud-based enclave. The further objectives of present disclosure are discussed below.

Another objective of the present disclosure is to provide a secure verification with data reveal for maximum privacy with verifiable trust.

Another objective of the present disclosure is to prevent long term profiling to minimize historical tracking of user behaviors.

Another objective of the present disclosure is to secure collaborative AI training.

Yet another objective of the present disclosure is to improve user trust and customization.

Still another objective of the present invention is to provide sustainable agent effectiveness and innovation.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for preventing breach of user privacy in a secure cloud-based enclave. The method comprises receiving, by a data acquisition module associated with the secure cloud-based enclave, user data from external sources. The data acquisition module classifies the user data into multiple categories, such as general information, personal information, and secret information. The data acquisition module applies data transformations to the user data based on the multiple categories to generate transformed data. Further, a training module associated with the secure cloud-based enclave, trains user-specific Artificial Intelligence (AI) models based on the transformed data. Furthermore, an AI agent associated with the secure cloud-based enclave executes the user-specific AI models to perform an action associated with the user data and provides a result of the action to an external system through an external interface.

In an aspect, the general information includes data related to general preferences or publicly available choices of a user. The personal information includes data related to sensitive and non-critical information of the user. The secret information includes data related to sensitive and critical information of the user.

In an aspect, the AI agent provides the result of the action without allowing access to data associated with the personal information and secret information.

In an aspect, the one or more data transformations comprise process of information in clear, anonymization, random numeric mapping, and indexing and time hashing.

In an aspect, the process of information in the clear is performed on the general information. The anonymization and the random numeric mapping are performed on the personal information. The indexing and time hashing is performed on the secret information.

In an aspect, a mapping table associated with the random numeric mapping is stored internally within the secure cloud-based enclave.

In an aspect, the indexing and time hashing is performed through at least one of one-way hashing, time-bound validity, key rotation and ephemeral indices, and homomorphic encryption and Secure Multi-Party Computation (SMPC).

In an aspect, the secure cloud-based enclave is implemented with at least one of a blockchain registry, zero-knowledge proofs, enhanced ephemeral identities, multi-party secure training, user-centric privacy dial, real-time privacy risk scoring, and decentralized agent marketplace.

In an aspect, one or more user-specific AI models are trained using at least one of federated learning, differential privacy, and SMPC or homomorphic encryption.

In another embodiment, the present invention discloses a system for preventing breach of user privacy in a secure cloud-based enclave. The system comprises one or more processors associated with the secure cloud-based enclave and a memory storing programmed instructions executable by the one or more processors. The one or more processors execute the programmed instructions to receive, by a data acquisition module associated with the secure cloud-based enclave, user data from external sources. The data acquisition module classifies the user data into multiple categories, such as general information, personal information, and secret information. The data acquisition module applies data transformations to the user data based on the multiple categories to generate transformed data. Further, a training module associated with the secure cloud-based enclave, trains user-specific Artificial Intelligence (AI) models based on the transformed data. Furthermore, an AI agent associated with the secure cloud-based enclave executes the user-specific AI models to perform an action associated with the user data and provides a result of the action to an external system through an external interface.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a system for managing a secure cloud-based enclave without any breach of user privacy, in accordance with an embodiment of the present disclosure;

FIG. 2 illustrates an exemplary block diagram representation of a computer implemented system, such as those shown in FIG. 1, capable of managing a secure cloud-based enclave without any breach of user privacy, in accordance with an embodiment of the present disclosure;

FIG. 3 illustrates an exemplary flow diagram representation of managing a secure cloud based enclave without any breach of user privacy, in accordance with an embodiment of the present disclosure; and

FIG. 4 illustrates a flow chart of a method for preventing breach of user privacy in a secure cloud-based enclave, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is therefore intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for managing a secure cloud-based enclave wherein the data related to agent is stored, accessed and trained without breach of user privacy.

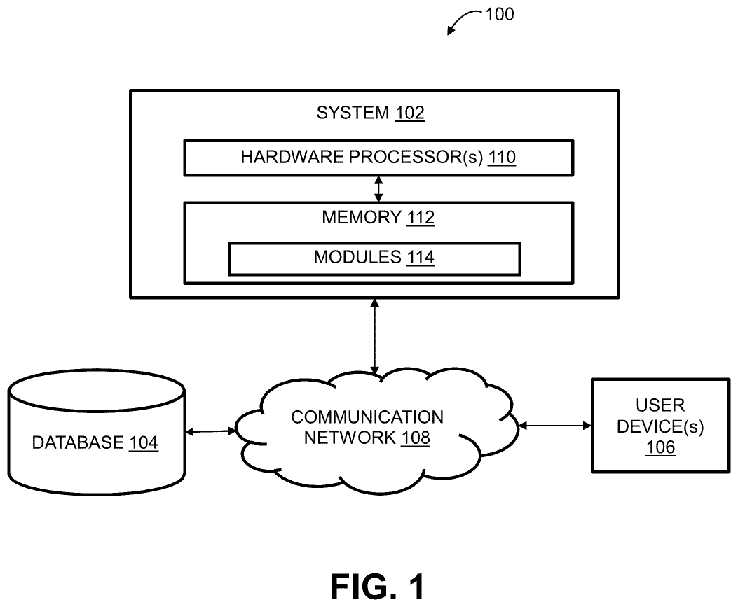

Referring now to the drawings, and more particularly to FIGS. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system 102 for managing a secure cloud-based enclave wherein the data related to agent is stored, accessed and trained without breach of user privacy, in accordance with an embodiment of the present disclosure. According to FIG. 1, the network architecture 100 includes a system 102, a database 104, and one or more user devices 106. The one or more user devices 106 may be associated with one or more users and communicatively coupled to the system 102 via a communication network 108. In an exemplary embodiment of the present disclosure, the user devices 106 may include a laptop computer, desktop computer, tablet computer, smartphone, wearable device, digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for managing a secure cloud-based enclave wherein the data related to agent is stored, accessed and trained without breach of user privacy. The user device 106 may be at least one of, an electrical, an electronic, an electromechanical, and a computing device. The user device 106 may include, but is not limited to, a mobile device, a smartphone, a Personal Digital Assistant (PDA), a tablet computer, a phablet computer, a wearable computing device, a Virtual Reality/Augmented Reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for managing a secure cloud-based enclave wherein the data related to agent is stored, accessed and trained without breach of user privacy. Execution of the machine-readable program instructions by the hardware processor 110 may enable the proposed system 102 for managing a secure cloud-based enclave wherein the data related to agent is stored, accessed and trained without breach of user privacy. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), wireless (e.g., Wireless-Fidelity (Wi-Fi)) adapter, graphics adapter, disk controller, Input/Output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may securely for managing a secure cloud-based enclave wherein the data related to agent is stored, accessed and trained without breach of user privacy.

In an exemplary embodiment, the system 102 is configured to embed unyielding privacy assurances and construct fortified enclaves for numerous users within a public utility cloud network.

In an exemplary embodiment, the system 102 may retrieve user data to train the artificial intelligence (AI) agents while steadfastly upholding user privacy without compromise.

In an exemplary embodiment, the system 102 may establish a range of API and protocols to facilitate interactions between public or corporate AIs and the AI agents. For example, a specific protocol could entail the capability of a corporate AI, such as external AI system to engage in a bidding/payment process for the compute time of an AI agent. This transaction would facilitate the delivery of product, brand, or marketing information to the AI agent, which the AI agent might then utilize for recommending actions or making decisions preapproved by the user.

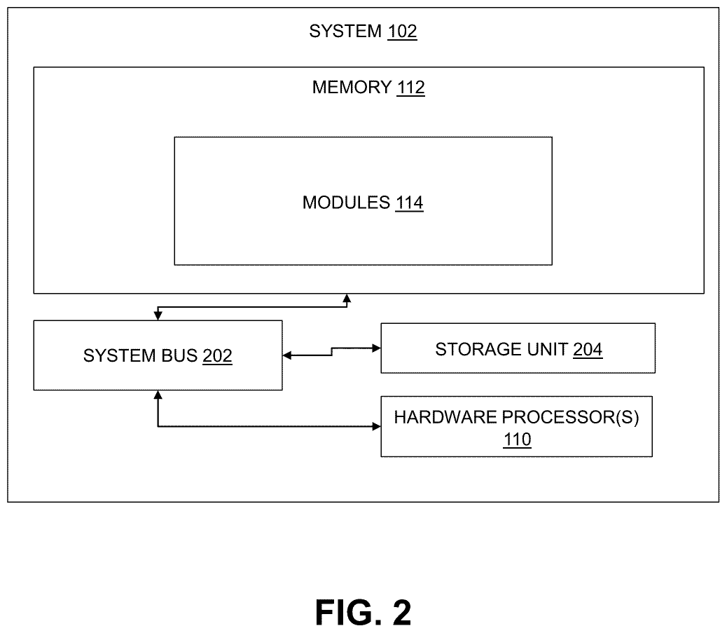

FIG. 2 illustrates an exemplary block diagram representation of a computer implemented system 102, such as those shown in FIG. 1, capable of securely managing a secure cloud-based enclave wherein the data related to agent is stored, accessed and trained without breach of user privacy, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, resources, privacy guidelines, network data, protocols or APIs, product/brand/marketing information, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may be securely managing a secure cloud based enclave wherein the data related to agent is stored, accessed and trained without breach of user privacy.

In an exemplary embodiment, the plurality of modules 114 may be configured to embed unyielding privacy assurances and construct fortified enclaves for numerous users within a public utility cloud network.

In an exemplary embodiment, the plurality of modules 114 may retrieve user data to train the Artificial Intelligence (AI) agents while steadfastly upholding user privacy without compromise.

In an exemplary embodiment, the plurality of modules 114 may establish a range of API and protocols to facilitate interactions between public or corporate Ais (external AI system) and the AI agents. For example, a specific protocol could entail the capability of the external AI system to engage in a bidding/payment process for the compute time of an AI agent. This transaction would facilitate the delivery of product, brand, or marketing information to the AI agent, which the AI agent might then utilize for recommending actions or making decisions preapproved by the user.

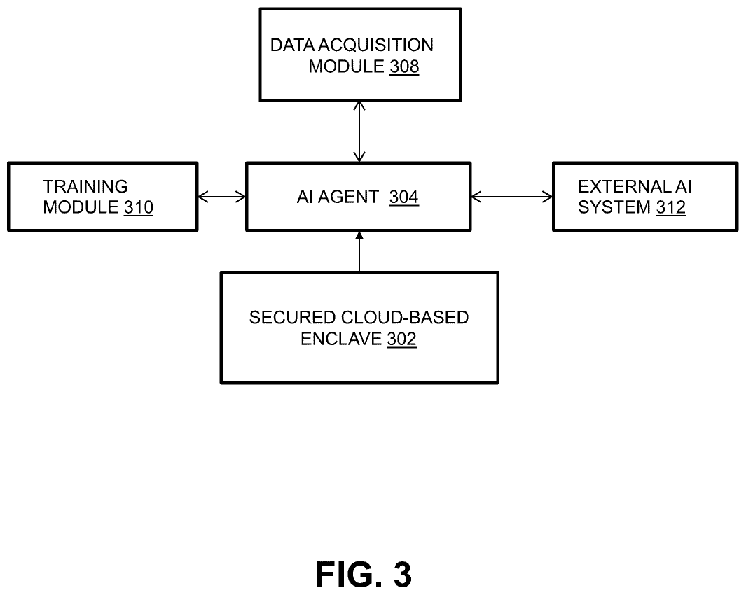

FIG. 3 illustrates an exemplary flow diagram representation of securely managing a secure cloud-based enclave 302 without breach of user privacy, in accordance with an embodiment of the present disclosure. A secured cloud-based enclave 302 may be established through the collaborative efforts of a plurality of modules 114. The secure cloud-based enclave 302 incorporates a sophisticated, tiered information classification scheme designed to proactively manage user data according to sensitivity and associated risks. The secured cloud-based enclave 302 functions as a meticulously engineered digital environment explicitly designed for the storage, access, and training of AI agents 304 while giving the utmost priority to safeguarding user data privacy. Within this framework, a data acquisition module 308 is responsible for accessing user data, which is subsequently employed in a training module 310 for training of AI agents 304, all while maintaining the highest standards of user data privacy. Additionally, a range of APIs and protocols is defined to facilitate interactions between the external AI system 312 and the AI agents 304. For instance, one such protocol allows the external AI system 312 to partake in a bidding/payment process for the compute time of the AI agent 304. This arrangement enables seamless delivery of product, brand, or marketing information to the AI agent 304, which the AI agent 304 can then utilize for suggesting actions or making decisions preapproved by the user. For another example, consider a hypothetical scenario where a consortium of leading technology companies collaborates with government agencies to establish an AI agent cloud ecosystem. The training of AI agents necessitates substantial computing resources, akin to a public utility model, fortified with stringent, embedded privacy safeguards. Imagine this as a vast digital infrastructure, akin to a secure AI training ground, where data privacy is an inherent feature. The cloud infrastructure, orchestrated by the joint effort of tech giants and government entities, is made freely accessible to individual users. Just as public utilities are accessible to all citizens, this cloud envisions providing a level playing field for users to harness the potential of advanced AI technologies without any financial barriers. The exceptional computing capabilities within this ecosystem empower individuals to cultivate highly proficient AI agents 304, fine-tuned to their unique data, preferences, and needs. Crucially, these AI agents 304 operate in a privacy-conscious manner, ensuring that user data remains off-limits to private corporations or any unauthorized access. Perhaps the innovative facet of this ecosystem is its potential to revolutionize digital marketing. In this landscape, marketers target AI agents 304 directly rather than individual users. The cost of marketing is calculated based on the compute cycles required for AI agents 304 to engage with and process marketing content. This paradigm shift not only enhances user privacy but also makes marketing interactions more cost-efficient and tailored to the AI agent's understanding, rather than relying on traditional user profiling.

Referring to FIG. 3, the flow of control and data between various components within the secured cloud-based enclave 302 is described. The system 102 is engineered to manage the ingestion, transformation, and processing of user data while strictly enforcing privacy at each phase. Each module has a specific role in this workflow, and control shifts sequentially, governed by data classification, policy enforcement, and secure execution boundaries. The secured cloud-based enclave 302 may act as a master controller to secure execution and governance layer. The secured cloud-based enclave 302 may initialize and monitor all plurality of modules 144, such as the data acquisition module 308, the training module 310, the AI agent 304 and the external AI system 312. The secured cloud-based enclave 302 may be implemented using hardware-based isolated processors with encrypted memory and secure boot. The secured cloud-based enclave 302 may strictly enforce cryptographic policies and remote attestation. Upon system start-up, the secured cloud-based enclave 302 grants execution control to the data acquisition module 308, while continuing to enforce policy constraints and boundary protections.

The data acquisition module 308 may receive user data from one or more external sources. The user data may be received through the secure cloud-based enclave 302. The data acquisition module 308 may be the first point of contact for user data ingestion. The data acquisition module 308 may classify the user data into multiple categories, such as general information, personal information, and secret information. The general information may be public data like general preferences or publicly available user choices (e.g., interest in sports, generalized demographic information). The personal information may be sensitive data which potentially contains Personally Identifiable Information (PII). The personal information may comprise sensitive but non-critical data (like individual preferences or browsing habits). The secret information may be highly sensitive, containing critical personal or financial details, such as credit cards and medical records. The classifications ensure that the most appropriate privacy and security protocols are enforced according to the sensitivity of data handled by the secure cloud-based enclave 302.

The data acquisition module 308 may apply one or more data transformations on the user data based on the categories to generate transformed data. Depending on the sensitivity classification (general information, personal information, secret information), the data acquisition module 308 applies tailored methods to safeguard privacy while allowing secure, useful interactions. The data acquisition module 308 employs four distinct information processing techniques, such as processing information in the clear, anonymization, random numeric indexing, and timed hashing to prevent replay attacks.

The secure cloud-based enclave 302 may process the general information plainly in the clear. The processing may be performed openly within the secure cloud-based enclave 302. Standard encryption (TLS 1.3, AES-256 at rest) may be applied to the general information for security purposes. The transformed general information may be accessible to external devices via secured REpresentational State Transfer (REST) or Remote Procedure Call (RPC) Application Programming Interfaces (APIs) without anonymization.

The secure cloud-based enclave 302 may process the personal information by stripping and generalization. For example, the AI Agent's identity is never explicitly linked to processed data. The personal information may be processed by removing explicit identifiers, such as names, email addresses, and precise location. Further, the personal information may be generalized. For example, “Alice Smith prefers Italian cuisine” may be processed to “User X prefers Italian cuisine”. Furthermore, the secure cloud-based enclave 302 utilizes differential privacy techniques, such as adding noise statistically to anonymize. In an example, if Alice has interest in health supplements, the external AI system receives “a user interested in supplements,” without revealing Alice's identity.

In an alternate embodiment, the secure cloud-based enclave 302 may apply random numeric indexing to at least one of the personal information and the general information when enhanced security is desired. The secure cloud-based enclave 302 randomly assigns numeric indexes to sensitive categorical interests (e.g., “Sci-Fi” becomes 39481). Further, the secure cloud-based enclave 302 securely maintains the mappings internally. This approach allows external systems to operate using numeric indices without exposing actual user interests. In this approach, the secure cloud-based enclave 302 may generate a secure, random numeric mapping (e.g., via cryptographically secure pseudorandom generators). Further, it maintains secure mappings in encrypted form internally (accessible only within the enclave). The external systems interact using these numeric indices, unable to perform reverse engineering without internal enclave mappings. For example, Alice's interest (“Sci-Fi”) is stored internally as: Sci-Fi→39481. An external marketing AI only sees “user interested in category 39481,” unable to infer exact details without internal mappings.

The secure cloud-based enclave 302 may process the secret information using secure hashing with a cryptographic seed or timestamp-based expiration. Such hashing ensures that the data cannot be replayed maliciously if intercepted or exposed. In the implementation, sensitive data may be hashed with a cryptographic algorithm (e.g., SHA-256 or SHA-3) combined with a secret seed and/or timestamp. The secure cloud-based enclave 302 may securely store the secret seed inside the secure cloud-based enclave 302 or periodically rotated. Time-bound hashes are valid only for a defined window, after which they become invalid (preventing replay attacks). Below is an example of hash generation.

ini

### CopyEdit

$$Hash = SHA - 256 ( UserData + Seed + Timestamp )$$

Hash valid only within Timestamp ±5 mins. Afterward, data hash is invalidated.

In an example, Alice's medical prescription information is securely hashed with a timestamp, allowing a pharmacy AI to verify prescription validity temporarily. After the allowed time window, the hash becomes invalid, blocking further or malicious reuse attempts.

Table 1 provides mapping processing techniques to information categories.

TABLE 1

| | General | Personal | Secret |
|---|---|---|---|
| Technique | Information | Information | Information |
| Processing | Required | Not | Not |
| in Clear | | recommended | recommended |
| Anonymization | Optional | Required | Not |
| | | | recommended |
| | | | (Not sufficient |
| | | | alone) |
| Numeric | Optional | Required | Not |
| Indexing | | | recommended |
| | | | (Not sufficient |
| | | | alone) |
| Timed Hashing | Not | Optional | Required |
| (prevent replay | recommended | (enhanced) | (Strongly |
| attacks) | | | recommended) |

In an example, Alice interacts with healthcare AI. General information may comprise Alice is interested in yoga. The general information is stored openly, and it may be shared with third-party wellness AI for curated recommendations.

In the above example, the personal information may comprise Alice frequently searches “stress relief methods.”. The personal information may be anonymized to “User interested in stress relief.” Furthermore, the personal information may be processed with random numeric indexing, such as “stress relief” may be indexed as 74213. The external wellness AI may extract interest category “74213” without specific details of Alice.

In the above example, the secret information may comprise Alice's medical records and prescription details. The secret information may be data hashed with timestamp and seed. For example, Pharmacy AI verifies a prescription through a hash. For example, PrescriptionHash=SHA-256 (prescription details +enclave seed +timestamp). The hash may be expired after a pre-defined time (5 minutes), rendering replay attempts useless and safeguarding Alice's sensitive data.

Thus, the secure cloud-based enclave 302 applies graduated treatment to data based on its sensitivity. For example, the general information may be processed directly but still resides within a secure, encrypted boundary, the personal information may be anonymized or abstracted, with all identifiers stripped or replaced by pseudonyms or numeric indexes, and the secret information, such as health records or financial data, is hashed with cryptographic keys and timestamp constraints, ensuring that any external representation is irreversible and has a finite lifespan.

The secure cloud-based enclave 302 incorporates a range of cryptographic strategies specifically designed to prevent reversibility. For example, one-way Hashing functions, such as SHA-256 or SHA-3 transform data into non-reversible digests. When combined with salts, seeds, or timestamps, these hashes become even more resistant to collision or brute-force reconstruction. Another example is Time-Bound Validity. By embedding a temporal component into the hashing process, the secure cloud-based enclave 302 ensures that even if a hash is captured, it becomes useless after a predefined time window. Yet another example is Key Rotation and Ephemeral Indices. Regular changes in the indexing scheme and cryptographic keys make it virtually impossible for an attacker to accumulate or correlate data points over time. Yet another example is Homomorphic Encryption and SMPC. In cases where computation on sensitive data is required, such as training AI agents or generating recommendations, the enclave employs privacy-preserving computation methods. These allow mathematical operations on encrypted data without exposing the raw data itself, ensuring the internal state never leaks.

Once the user data is classified and transformed, the control shifts to the training module 310 for updating AI models. The original data is not retained beyond this phase unless permitted by policy. The training module 310 may perform learning or finetuning operations on the transformed data. For example, the training module 310 may train or update user-specific AI models in isolation. For training of the AI models, techniques, such as federated learning, differential privacy, and Secure Multi-Party Computation (SMPC) or homomorphic Encryption may be applied. Once training is complete, model updates are securely handed off to the AI Agent 304. The module does not retain access to user-specific data or model behavior after handoff.

The AI model 304 may be a personalized user model that operates independently inside the secure cloud-based enclave 302. The AI model 304 may execute inferences, make recommendations, or engage in decision-making. The AI model 304 may maintain private mappings (e.g., index to interest), user policy states, and training history. The mappings are not accessible outside the secure cloud-based enclave 302. The AI Agent 304 may assume control over interactions with external entities. However, it does so only through enclave-sanctioned APIs, invoking policies that dictate what can or cannot be shared.

The external AI system 312 may seek interaction with the AI model 304. Examples of the external AI system may include, but not limited to, marketing engine, calendar, and e-commerce recommender. The external AI system 312 may engage via controlled APIs exposed by the secure cloud-based enclave 302. Further the external AI system 312 may request compute cycles on the AI Agent 304. The interaction between the external AI system 312 and the AI Agent 304 are permitted only via bidding/payment protocols and only if pre-approved by user-defined policy. The external AI system 312 never gain control. They request interaction and receive responses, but data access, computation, and even interpretations are entirely managed and mediated by the AI agent 304 under enclave governance.

Further, the secure cloud-based enclave 302 does not provide access to external AI to internal state. The enclave's most critical technical safeguard is its ability to completely isolate internal data structures and logic. The secure cloud-based enclave 302 does not even allow the cloud provider hosting the secure cloud-based enclave 302 to access memory, storage, or the execution state of the enclave once it is initialized and cryptographically attested. Further, data mappings, such as those between numeric indices and actual user preferences, are stored exclusively within the secure cloud-based enclave 302. These mappings are never shared, exported, or cache outside the trusted boundary. The internal exclusivity ensures that even if two external agents happen to use the same numeric identifier (e.g., “Category 58291”), they cannot infer what it means without enclave access.

Furthermore, the secure cloud-based enclave 302 actively defends against the risk of replay or impersonation. Hashes or tokens issued by the enclave expire rapidly, making it unfeasible to reuse them in future contexts or aggregate them into a long-term user profile. Forward secrecy is maintained by destroying session-specific keys after each interaction. This ensures that even if one transaction's data is compromised, it cannot be used to compromise past or future interactions.

The secure cloud-based enclave 302 may be cryptographically logged in an immutable audit trail, optionally backed by blockchain or append-only secure storage. Further, the secure cloud-based enclave 302 may be auditable by regulators, security tools, or the users themselves without compromising the content of what was processed.

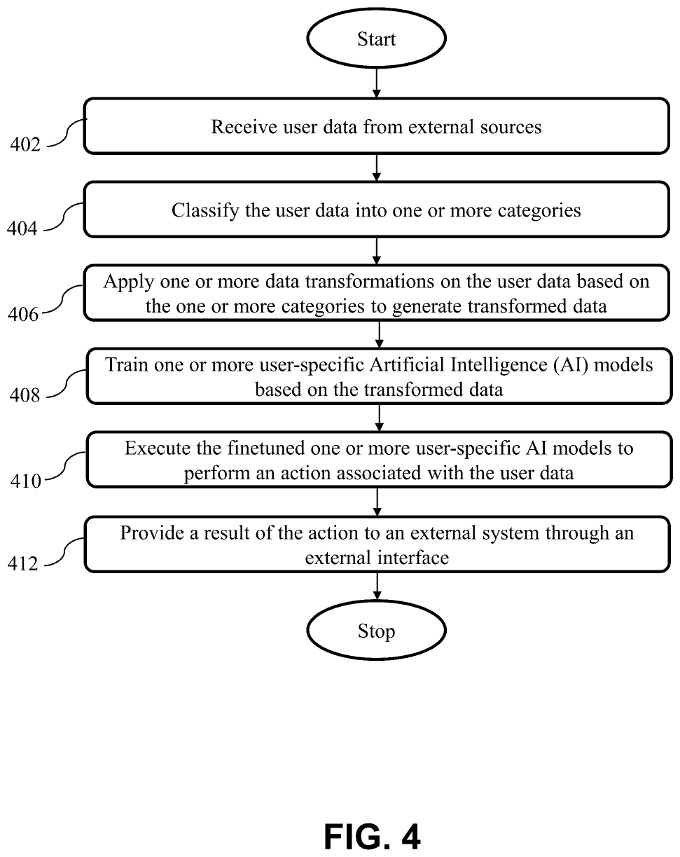

FIG. 4 illustrates a flow chart of a method 400 for preventing breach of user privacy in the secure cloud-based enclave 302, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, the data acquisition module 308 associated with the secure cloud-based enclave 302 may receive the user data from one or more external sources. The secure cloud-based enclave 302 may be implemented with at least one of a blockchain registry, zero-knowledge proofs, enhanced ephemeral identities, multi-party secure training, user-centric privacy dial, real-time privacy risk scoring, and decentralized agent marketplace. At block 404, the data acquisition module 308 may classify the user data into one or more categories. The one or more categories may include general information, personal information, and secret information. The general information may be public data like general preferences or publicly available user choices (e.g., interest in sports, generalized demographic information). The personal information may be sensitive data which potentially contains PII. The personal information may comprise sensitive but non-critical data (like individual preferences or browsing habits). The secret information may be highly sensitive, containing critical personal or financial details, such as credit cards and medical records.

At block 406, the data acquisition module 308 may apply one or more data transformations on the user data based on the one or more categories to generate transformed data. The data acquisition module 308 employs four distinct information processing techniques, such as processing information in the clear, anonymization, random numeric indexing, and timed hashing to prevent replay attacks. The process of information in the clear may be performed on the general information, the anonymization and the random numeric mapping may be performed on the personal information, and the indexing and time hashing may be performed on the secret information. The mapping table associated with the random numeric mapping is stored internally within the secure cloud-based enclave 302. The indexing and time hashing is performed through at least one of one-way hashing, time-bound validity, key rotation and ephemeral indices, and homomorphic encryption and Secure Multi-Party Computation (SMPC).

At block 408, the training module 310 may train one or more user-specific AI models based on the transformed data. The one or more user-specific AI models are trained using at least one of federated learning, differential privacy, and SMPC or homomorphic encryption. At block 410, the AI agent 304 may execute the finetuned one or more user-specific AI models to perform an action associated with the user data. At block 412, the AI agent 304 may provide a result of the action to the external AI system 314 through an external interface. The AI agent 304 may provide the result of the action without allowing access to data associated with the personal information and secret information.

### Exemplary Formation of Secure Enclaves for Plurality of Users

Consider a scenario where a government consortium is responsible for various critical functions, such as national security, public healthcare, and disaster response. This consortium leverages a public utility cloud network to facilitate efficient data sharing and collaboration among government agencies. In this scenario, the method is deployed to create secure enclaves within the cloud network, uniquely designed to meet the privacy and security requirements of government users. These enclaves are hardwired with advanced privacy measures, ensuring that classified government data remains confidential and protected from any external threats. For instance, a federal agency responsible for national security can securely exchange sensitive intelligence information with other authorized agencies. The enclave guarantees that this information is only accessible to individuals with the appropriate security clearance, thereby upholding the highest standards of data protection.

### Exemplary Scenario 1:

The system 102 may possess the capability to manage a secure cloud-based enclave without breach of user privacy. Consider a collaboration between leading technology companies and government agencies, an AI agent cloud ecosystem is envisioned. The system 102, fortified with stringent privacy measures, facilitates the training of AI agents 304 by providing substantial computing resources, similar to a public utility model, while ensuring the confidentiality of user data. Accessible freely to individual users, it empowers them to cultivate highly personalized AI agents 304 that respect their privacy, and it introduces a transformative approach to digital marketing, where AI agents 304 are the primary audience, improving both user privacy and the efficiency of marketing efforts.

### Exemplary Scenario 2:

Consider a secure cloud-based enclave 302 tailored for AI agents 304. It anticipates extensive computational resources for AI agent 304 training and envisions a public utility model with stringent privacy protections. The operation of this cloud could involve a collaboration between technology companies and government statutory bodies, with free user access, allowing individuals to create highly personalized AI agents 304 while ensuring data privacy. Additionally, the infrastructure's availability may revolutionize digital marketing by directing marketing efforts towards AI agents 304, with the cost tied to compute cycles, ensuring user privacy, safeguard privacy, define communication protocols, and facilitate secure interactions, including protocols allowing external AI systems to engage with AI agents 304 for marketing while respecting user preferences, making this initiative government-led and privacy-conscious.

The secured cloud-based enclave 302 may be implemented by creating a digitally isolated processing zone, such as a Trusted Execution Environment (TEE). In TEE, AI agents may be stored, accessed, and trained without exposure to external systems or administrators. Trusted hardware may be used to guarantee the isolation of the secured cloud-based enclave 302 from the host Operating System (OS) and hypervisor. Remote attestation protocols cryptographically may verify that only approved code and models are running before data can be ingested or processed. Memory and disk encryption may ensure that enclave data, even if captured outside the enclave boundary (e.g., through physical access or VM snapshots), is unusable.

The secured cloud-based enclave 302 strictly controls how the user data is handled throughout its lifecycle, such as storage, access, processing, and deletion. The user data may be handled based on the classification (general information, personal information, and secret information). The transformation of the user data may be performed using multiple key mechanisms. For example, the secured cloud-based enclave 302 may include a data classification module that automatically tags data at ingestion. Further, anonymization and pseudonymization techniques may be used for personal information. One-way hashing with time-bound validity may be used for secret or critical data (e.g., credit cards, medical records). The output or inference results are filtered or transformed to avoid indirect leakage.

The training module 310 may perform training, fine-tuning, and inference operations of the AI agents 304 within the secured cloud-based enclave 302 without compromising data privacy. The training, finetuning, and inference operations may be performed through at least one of federated learning, homographic encryption, and Secure Multi-Party Computation (SMPC). In the federated learning, distributed agents, model updates (not raw data) are aggregated securely inside the enclave. Homomorphic encryption allows certain computations directly on encrypted inputs without needing decryption. SMPC supports collaborative model development across enclaves without any one party accessing the full data. The AI agents 304 receive training inputs through the data acquiring unit 308, which ensures privacy-preserving transformation of the inputs before training.

The secured cloud-based enclave 302 allows external entities (e.g., corporations, platforms) to interact with the AI agent 304 without direct access to the user's data or model. External requests are validated for permission and scope before being allowed. Only approved external AIs can pay for or bid on interaction rights (compute cycles, not data access). Data exchanged between the enclave and the external party is encrypted and decrypted only within the secured cloud-based enclave 302. For instance, a marketing AI may pay to deliver product metadata to an agent but cannot receive personal responses or user data in return-only computed insights if allowed by policy.

The secured cloud-based enclave 302 ensures that all operations comply with the user's privacy preferences and access policies. A policy enforcement engine inside the enclave checks every incoming or outgoing request against user-approved rules. The Dynamic privacy profiles users can define thresholds (e.g., allow only anonymized data to be used for training). Any interaction that violates policy (e.g., data sharing outside approved windows) is rejected and logged.

The present invention proposes a secure cloud-based enclave that houses AI agents. The secure cloud-based enclave performs classification and anonymization of user information before external sharing, eliminating direct exposure. External entities (e-commerce, service providers) interact via compute-time interactions, ensuring no raw sensitive information ever leaves the secure cloud-based enclave. AI agents abstract personal preferences using anonymization, numeric indexing, and secure hashing. Users seamlessly transfer agents between platforms with only minimal necessary data transferred, preventing profile collation over time. Numeric indexing and hashing with limited validity ensure temporal isolation, making it impossible for companies to build lasting profiles or histories on individuals. Use of secure enclaves allows full-featured, sophisticated AI training on complete user data internally. The secure cloud-based enclave allows detailed insights to be generated without external exposure, maintaining effectiveness without privacy compromise. It utilizes blockchain smart contracts to manage AI agent ownership, permissions, and agent portability transparently. The blockchain smart contracts adds transparency and trust in the portability process, clearly delineating information boundaries and usage history.

In a practical example, consider that a consortium of advertising companies wants to deliver personalized advertisements to users while strictly preserving user's privacy. In such a scenario, the consortium may establish the secure cloud-based enclave 302. The secure cloud-based enclave 302 acts as a privacy-preserving environment where user data can be processed and AI agents can be trained without exposing the underlying data to the advertising companies. The user data may be fixed, such as a product purchase from an e-commerce site or inferred, such as user's interest in fashion based on browsing behavior. These data may be collected from various sources and provided to the secure cloud-based enclave 302. The secure cloud-based enclave 302 may trigger the data acquisition module 308 to classify the user data into categories, such as general information, personal information, and secret information. Further, the data acquisition module 308 may transform the user data to protect user's privacy. For example, personal information might be anonymized and secret information might be hashed. The data acquisition module 308 may further take requests from external agents, such as a “friend” agent or a “work” agent, each potentially having its own knowledge base.

The training module 310 may fetch the transformed user data from the data acquisition module 308. Further, the training module 310 may refine the knowledge of user preferences and behaviors and may store the user preferences and behaviors within the secure cloud-based enclave 302. For instance, the training module 310 may refine a general interest in “fashion” to a more specific interest in “casual fashion” versus “business fashion.”

Further, the data may be passed to the external AI system 312, such as a recommendation engine, based on a specific user action (e.g., shopping). The secure cloud-based enclave 302 may share merely shopping-related information which is anonymized to protect privacy. In addition, information from external agents (e.g., a “friend” agent) can also be queried and passed to the external AI system 312.

The information from external agents may or may not be assimilated into the AI agent 304. The AI agent 304 may execute selective assimilation that helps to secure data and protect user information by avoiding the storage of unnecessary or contextually irrelevant data. Finally, the external AI system 312 may use the received information to provide more relevant recommendations, such as, recommending casual fashion items instead of business fashion items. The advertising companies can deliver targeted ads without directly accessing or mishandling user data.

The present invention provides an extremely powerful system for privacy, enabling data verification without revealing the sensitive details themselves, significantly enhancing your privacy approach. Furthermore, the AI agents periodically rotate or regenerate user identities and indices, further preventing long-term profiling. The system provides regularly scheduled cryptographic key rotation and numeric index updates within the secure cloud-based enclaves. Thus, the system reduces the potential of collating information over prolonged timeframes by automatically invalidating older data.

The system further allows multiple agents to train AI models collaboratively through SMPC, ensuring none can reconstruct raw user data. Thus, the system enhances training effectiveness through collaborative learning without sacrificing user-level privacy. Furthermore, the system provide users with fine-grained privacy control sliders (“privacy dial”) letting them actively select trade-offs between personalization levels and privacy to empower users, enhancing trust, personalization, and transparency.

Furthermore, the system implements a real-time scoring system within enclaves that evaluates and flags potential privacy risks before data-sharing or agent porting. Thus, the system adds an intelligent, proactive protection layer, enhancing user confidence and data security. The system builds a decentralized marketplace allowing users to securely upgrade, exchange, or sell AI agent modules (skills, datasets, behaviors) transparently and safely to encourage innovation, maintains agent effectiveness, and supports open innovation.

The secure cloud-based enclave is a secure processing environment that is a foundational privacy infrastructure designed to ensure that data, once ingested and processed according to its classification, cannot be reconstructed outside the enclave and no external system can correlate, collate, or reverse-map user data from outputs like hashes, indices, or model inferences. Further, the secure cloud-based enclave enforces strong one-way transformations, cryptographic isolation, time-limited representations, and secure compute boundaries that together make data irreversibility a technical certainty, not merely a policy.

A processor may include one or more general purpose processors and/or one or more special purpose processors (e.g., digital signal processors, System On Chip (SOC), and Field Programmable Gate Array (FPGA) processor), a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

For the sake of brevity, the construction and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms, internal corporate cloud computing clusters or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for the management of a secure cloud-based enclave, dedicated to the storage, access, and training of agent-related data, all while safeguarding user privacy. These embodiments emphasize the robust construction of fortified enclaves within a public utility cloud network, ensuring the privacy of numerous users. Furthermore, they facilitate the retrieval of user data to train artificial intelligence (AI) agents without any compromise on user privacy. Moreover, the present disclosure enables the establishment of a variety of APIs and protocols to facilitate seamless interactions between external AI systems and the AI agents. As an illustrative example, one of these protocols could involve corporate AI entities engaging in a bidding/payment process for access to the computational resources of an AI agent. This transaction framework serves to deliver product, brand, or marketing information to the AI agent, which may subsequently utilize this information for making recommendations or decisions, all within the user's preapproved parameters.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A method for preventing breach of user privacy in a secure cloud-based enclave, comprising:
receiving, by a data acquisition module associated with the secure cloud-based enclave, user data from one or more external sources;
classifying, by the data acquisition module, the user data into one or more categories, wherein the one or more categories comprise general information, personal information, and secret information;
applying, by the data acquisition module, one or more data transformations on the user data based on the one or more categories to generate transformed data;
training, by a training module associated with the secure cloud-based enclave, one or more user-specific Artificial Intelligence (AI) models based on the transformed data;
executing, by an AI agent associated with the secure cloud-based enclave, the finetuned one or more user-specific AI models to perform an action associated with the user data; and
providing, by the AI agent, a result of the action to an external system through an external interface.

2. The method according to claim 1, wherein
the general information includes data related to general preferences or publicly available choices of a user,
the personal information includes data related to sensitive and non-critical information of the user, and
the secret information includes data related to sensitive and critical information of the user.

3. The method according to claim 1, wherein the AI agent provides the result of the action without allowing access to data associated with the personal information and secret information.

4. The method according to claim 1, wherein the one or more data transformations comprise process of information in clear, anonymization, random numeric mapping, and indexing and time hashing.

5. The method according to claim 4, wherein
the process of information in the clear is performed on the general information,
the anonymization and the random numeric mapping are performed on the personal information, and
the indexing and time hashing is performed on the secret information.

6. The method according to claim 4, wherein a mapping table associated with the random numeric mapping is stored internally within the secure cloud-based enclave.

7. The method according to claim 4, wherein the indexing and time hashing is performed through at least one of one-way hashing, time-bound validity, key rotation and ephemeral indices, and homomorphic encryption and Secure Multi-Party Computation (SMPC).

8. The method according to claim 1, wherein the secure cloud-based enclave is implemented with at least one of a blockchain registry, zero-knowledge proofs, enhanced ephemeral identities, multi-party secure training, user-centric privacy dial, real-time privacy risk scoring, and decentralized agent marketplace.

9. The method according to claim 1, wherein the one or more user-specific AI models are trained using at least one of federated learning, differential privacy, and SMPC or homomorphic encryption.

10. A system for preventing breach of user privacy in a secure cloud-based enclave, comprising:
one or more processors associated with the secure cloud-based enclave; and
a memory storing programmed instructions executable by the one or more processors, wherein the one or more processors execute the programmed instructions to:
receive, by a data acquisition module associated with the secure cloud-based enclave, user data from one or more external sources;
classify, by the data acquisition module, the user data into one or more categories, wherein the one or more categories comprise general information, personal information, and secret information;
apply, by the data acquisition module, one or more data transformations on the user data based on the one or more categories to generate transformed data;
train, by a training module associated with the secure cloud-based enclave, one or more user-specific Artificial Intelligence (AI) models based on the transformed data;
execute, by an AI agent associated with the secure cloud-based enclave, the finetuned one or more user-specific AI models to perform an action associated with the user data; and
provide, by the AI agent, a result of the action to an external system through an external interface.

11. The system according to claim 10, wherein
the general information includes data related to general preferences or publicly available choices of a user,
the personal information includes data related to sensitive and non-critical information of the user, and
the secret information includes data related to sensitive and critical information of the user.

12. The system according to claim 10, wherein the AI agent provides the result of the action without allowing access to data associated with the personal information and secret information.

13. The system according to claim 10, wherein the one or more data transformations comprise process of information in clear, anonymization, random numeric mapping, and indexing and time hashing.

14. The system according to claim 13, wherein
the process of information in the clear is performed on the general information,
the anonymization and the random numeric mapping are performed on the personal information, and
the indexing and time hashing is performed on the secret information.

15. The system according to claim 13, wherein a mapping table associated with the random numeric mapping is stored internally within the secure cloud-based enclave.

16. The system according to claim 13, wherein the indexing and time hashing is performed through at least one of one-way hashing, time-bound validity, key rotation and ephemeral indices, and homomorphic encryption and Secure Multi-Party Computation (SMPC).

17. The system according to claim 10, wherein the secure cloud-based enclave is implemented with at least one of a blockchain registry, zero-knowledge proofs, enhanced ephemeral identities, multi-party secure training, user-centric privacy dial, real-time privacy risk scoring, and decentralized agent marketplace.

18. The system according to claim 10, wherein the one or more user-specific AI models are trained using at least one of federated learning, differential privacy, and SMPC or homomorphic encryption.

19. A non-transitory machine-readable medium including data, which when used by a system for augmenting recommendations through resource sharing between Artificial Intelligent (AI) agents, causes the system to perform instructions that cause the system to perform operations comprising:
receiving, by a data acquisition module associated with the secure cloud-based enclave, user data from one or more external sources;
classifying, by the data acquisition module, the user data into one or more categories, wherein the one or more categories comprise general information, personal information, and secret information;
applying, by the data acquisition module, one or more data transformations on the user data based on the one or more categories to generate transformed data;
training, by a training module associated with the secure cloud-based enclave, one or more user-specific Artificial Intelligence (AI) models based on the transformed data;
executing, by an AI agent associated with the secure cloud-based enclave, the finetuned one or more user-specific AI models to perform an action associated with the user data; and
providing, by the AI agent, a result of the action to an external system through an external interface.
